(19) United States
(12) Patent Application Publication
(10) Pub. No.: US 2019/0323251 A1
(43) Pub. Date: Oct. 24, 2019

(54) POOL CLEANING DEVICE

(71) Applicants: Frank Norberto, JR., Naples, FL (US); Frank Norberto, III, Naples, FL (US)

(72) Inventors: Frank Norberto, JR., Naples, FL (US); Frank Norberto, III, Naples, FL (US)

(21) Appl. No.: 15/960,625

(22) Filed: Apr. 24, 2018

(51) Int. Cl. E04H 4/16; B01D 29/27; B01D 29/60; B01D 35/157

(52) U.S. Cl. CPC E04H 4/1609; B01D 29/27; B01D 2201/0415; B01D 35/157; B01D 2201/167; B01D 29/603

(57) ABSTRACT

A pool cleaning device (1) for cleaning debris from the floor of a pool without the use of suction and/or a pool pump and an interchangeable netting system that allows a user to change the net (10) on the pool cleaning device or on a pool skimmer from a mesh size used for capturing small debris to a mesh size used for capturing large debris as necessary.

### FIELD OF THE INVENTION

This invention relates to pool maintenance and more particularly to a pool cleaning device used for cleaning debris off of the floor of a pool without the use of suction and/or a pool pump and an interchangeable netting system that allows a user to change the net on the sweeper or on a pool skimmer from a mesh size used for capturing small debris to a mesh size used for capturing large debris.

### BACKGROUND OF THE INVENTION

Debris on the bottom of a swimming pool is commonly cleaned using a vacuum head attached to an elongated pole. The vacuum head is attached to a pump and filter system via a hose that provides suction to the vacuum head to suck up debris. The use of conventional pool vacuums is time consuming as the hose must be unrolled and secured to the pump system and then to the vacuum head. Then, the hose and vacuum must be disassembled and stored.

This is a laborious task especially when there is minimal debris, such as a few leaves, that need to be cleaned off of the pool floor. Some try to capture debris off of the floor of a pool using a conventional pool skimmer. However, it is difficult to capture debris under water without the debris escaping from the net. In addition, conventional skimmers have permanently integrated nets each having a specific mesh size for capturing fine debris, such as gnats, dirt and so forth, or for capturing larger debris, such as leaves. Each mesh size has certain advantages and disadvantages. Therefore, it may be necessary for a pool owner pool maintenance worker to own more than one skimmer head to capture the various sizes of pool debris.

Therefore, a need exists for a pool cleaning device used for cleaning debris off of the floor of a pool without the use of suction and/or a pool pump and an interchangeable netting system that allows a user to change the net on the pool cleaning device or on a pool skimmer from a mesh size used for capturing small debris to a mesh size used for capturing large debris as necessary.

The relevant prior art includes the following references:

| Patent No. | | |
|---|---|---|
| (U.S. Patent References) | Inventor | Issue/Publication Date |
| 3,439,368 | Myers | Apr. 22, 1969 |
| 3,444,575 | Martin | May 20, 1969 |
| 3,822,754 | Henkin et al. | Jul. 9, 1974 |
| 4,558,479 | Greskovics et al. | Dec. 17, 1985 |
| 5,336,403 | Marbach | Aug. 9, 1994 |
| 6,971,136 | Horvath et al. | Dec. 6, 2005 |
| 2015/0128316 | Erlich et al. | May 14, 2015 |
| 9,828,785 | Heffernan | Nov. 28, 2017 |

### SUMMARY OF THE INVENTION

The primary object of the present invention is to provide a pool cleaning device used for cleaning debris off of the floor of a pool without the use of suction and/or a pool pump.

An additional object of the present invention is to provide an interchangeable netting system that allows a user to change the net on the pool cleaning device of the present invention or on a pool skimmer from a mesh size used for capturing small debris to a mesh size used for capturing large debris as necessary.

The present invention fulfills the above and other objects by providing a pool cleaning device for cleaning debris from a pool floor wherein the net is connected to a perimeter frame and covered by a trap door. The trap door is pushed open by the force water when the device is pushed forward. A mechanism, such as one or more springs and/or floats, pushes the trap door into a closed position when the debris capturing net is stationary or moved in a reverse direction, thereby trapping debris inside the net and preventing the debris from floating out of the net. A scoop on a front edge of the frame scrapes the surface of the pool floor and directs debris into the net. One or more rollers may be located below the scoop to allow the device to move freely along the surface of the pool floor.

The net of the present invention is preferably interchangeable by means of a band located around an upper perimeter of the net, said band preferably having a hook and loop fastener located on an outer surface that engages a hook and loop fastener located on an inner surface of the perimeter frame. The interchangeable net system of the present invention may be used with the debris capturing device and/or with a skimmer frame having a hook and loop fastener located on an inner surface thereof.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of a pool cleaning device of the present invention wherein a trap door is in closed position;

FIG. 2 is a perspective side view of a pool cleaning device of the present invention wherein a trap door is in an open position;

FIG. 3 is a side view of a pool cleaning device of the present invention wherein a trap door is in a closed position;

FIG. 4 is a side view of a pool cleaning device of the present invention wherein a trap door is in an open position;

FIG. 5 is a bottom view of a pool cleaning device of the present invention wherein a trap door is in a closed position;

FIG. 6 is a perspective side view of a perimeter frame of a pool cleaning device of the present invention with no covering panel and having a removable net attached thereto;

and

FIG. 7 is a perspective side view of a perimeter frame of a pool cleaning device of the present invention with no covering panel and having a removable net detached.

### DESCRIPTION OF THE PREFERRED EMBODIMENTS

For purposes of describing the preferred embodiment, the terminology used in reference to the numbered accessories in the drawings is as follows:
1. pool cleaning device, generally
2. perimeter frame
3. inner surface of perimeter frame
4. outer surface of perimeter frame
5. upper edge of perimeter frame
6. lower edge of perimeter frame
7. front section of perimeter frame
8. side section of perimeter frame
9. rear section of perimeter frame
10. net
11. cover panel
12. top surface of cover panel
13. bottom surface of cover panel
14. cover panel entrance hole
15. trap door
16. closing means
17. scoop
18. front edge of scoop
19. top surface of scoop
20. bottom surface of scoop
21. rolling means
22. wheel
23. band
24. upper perimeter of net
25. hook and loop fastener
26. attachment means
27. tubular extension
28. weight
29. support arm
30. spring
31. float

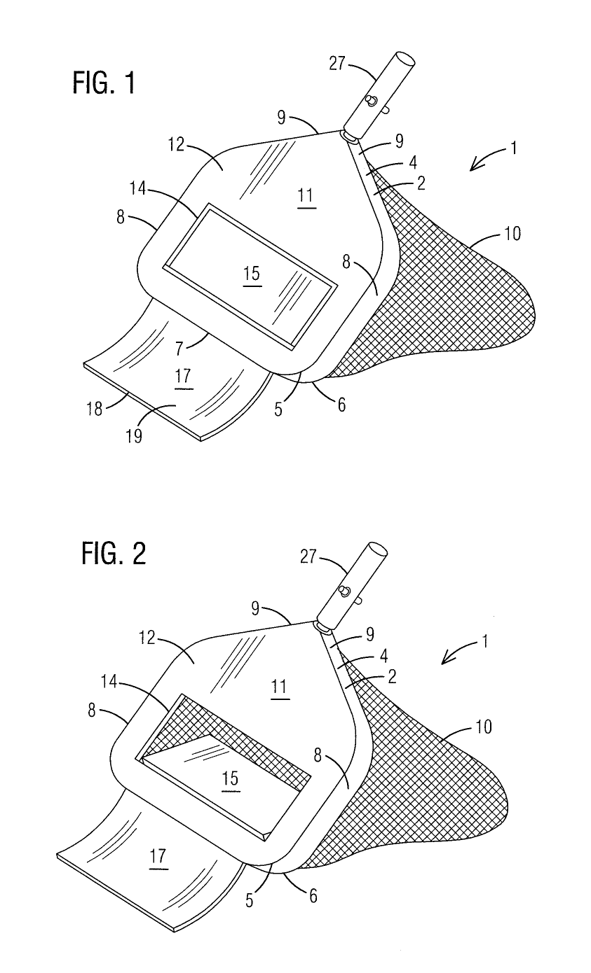

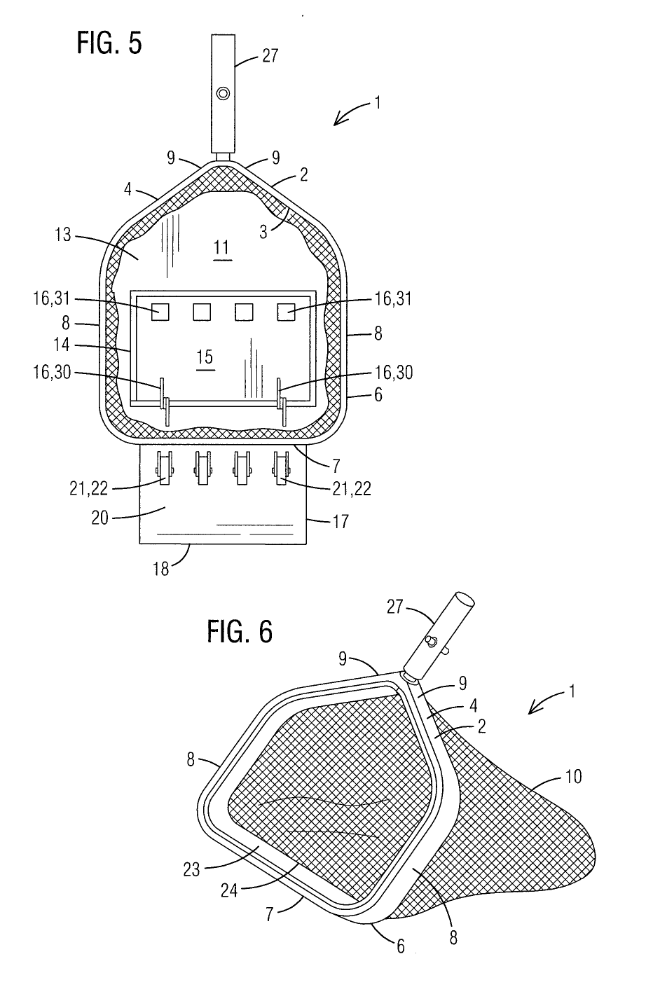

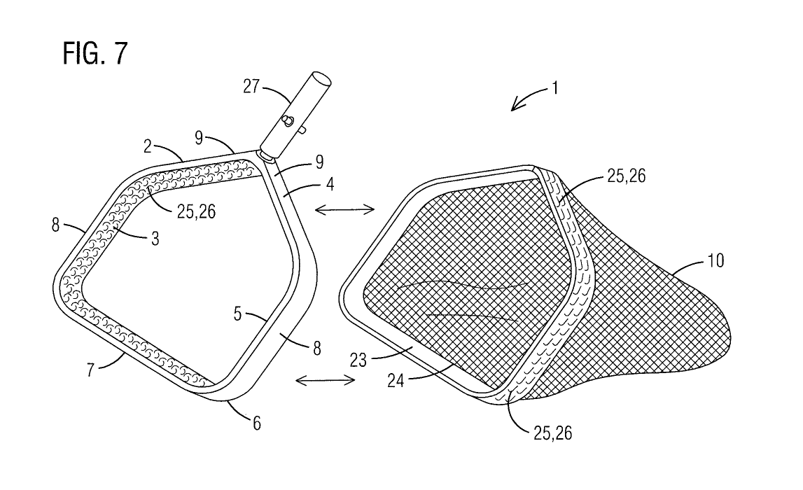

With reference to FIGS. 1 and 2, perspective side views of a pool cleaning device 1 of the present invention wherein a trap door 15 is in an open position and in a closed position, respectively, are illustrated. The pool cleaning device 1 of the present invention comprises a perimeter frame 2 having a rounded and/or rectangular shape. Said perimeter frame 2 comprises an inner surface 3 (as illustrated in FIG. 5), an outer surface 4, an upper edge 5, a lower edge 6, a front section 7, side sections 8 and at least one rear section 9. A net 10 extends downward from the perimeter frame 2 to form a bag for trapping debris that enters the pool cleaning device 1. The net 10 may be permanently attached to the perimeter frame 2 or removeably attached (as illustrated in FIGS. 6 and 7). A covering panel 11 having a top surface 12 and a bottom surface 13 (as illustrated in FIG. 5) extends across the perimeter frame 2 covering an opening to the bag-shaped net 10 created by the perimeter frame 2. A preferably rectangular-shaped entrance hole 14 is centrally located on the covering panel 11 and covered by a trap door 15, which is hingedly attached to the covering panel 11 and or perimeter frame 2. The trap door 15 is pushed open by the force of water when the pool cleaning device 1 is pushed forward. A substantially rectangular-shaped scoop 17 having a front edge 18, a top surface 19, and a bottom surface 20 (as illustrated in FIG. 5) extends from on the front section 7 of the perimeter frame 2 and scrapes the surface of the pool floor to direct debris into the net 10. A tubular extension 27 extends from the rear section 9 of the perimeter frame and acts as a handle or an attachment point for an elongated handle.

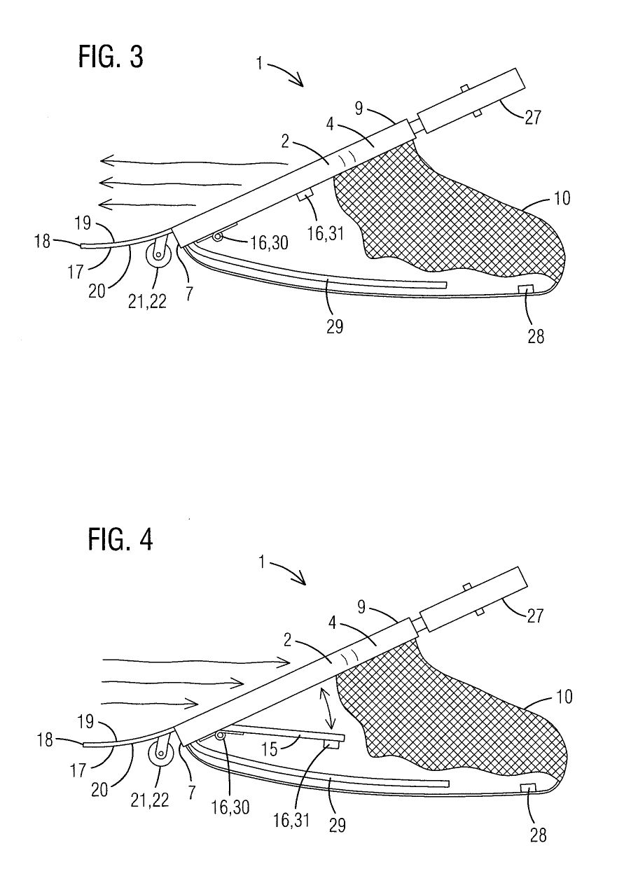

With reference to FIGS. 3 and 4, side views of a pool cleaning device 1 of the present invention wherein a trap door 15 is in an open position and in a closed position, respectively, are illustrated. The pool cleaning device 1 of the present invention comprises a perimeter frame 2 having a rounded and/or rectangular shape. A net 10 extends downward from the perimeter frame 2 to form a bag for trapping debris that enters the pool cleaning device 1. The net 10 may be permanently attached to the perimeter frame 2 or removeably attached (as illustrated in FIGS. 6 and 7). The net may be held in an expanded position by at least one weight 28 and or at least one support arm 29. The trap door 15 is pushed open by the force of water when the pool cleaning device 1 is pushed forward (as illustrated in FIG. 4). A closing means 16, such as at least one spring 30, at least one float 31 and so forth, pushes the trap door 15 into a closed position and maintains the trap door 15 in the closed position when the pool cleaning device 1 is not being pushed forward through the water, thereby capturing debris within the net 10. A substantially rectangular-shaped scoop 17 having a front edge 18, a top surface 19, and a bottom surface 20 extends from on the front section 7 of the perimeter frame 2 and scrapes the surface of the pool floor to direct debris into the net 10. At least one rolling means 21, such as at least one wheel 22, roller, caster and so forth, may be located on the bottom surface 21 of the scoop 17 and or perimeter frame 2 to allow the pool cleaning device 1 to move freely along the surface of the pool floor. A tubular extension 27 extends from the rear section 9 of the perimeter frame and acts as a handle or an attachment point for an elongated handle.

With reference to FIG. 5, a bottom view of a pool cleaning device 1 of the present invention wherein a trap door 15 is in a closed position and no net 10 attached is illustrated. The pool cleaning device 1 of the present invention comprises a perimeter frame 2 having a rounded and/or rectangular shape. Said perimeter frame 2 comprises an inner surface 3, an outer surface 4, an upper edge 5 (as illustrated in FIGS. 1 and 2), a lower edge 6, a front section 7, side sections 8 and at least one rear section 9. A covering panel 11 having a top surface 12 (as illustrated in FIGS. 1 and 2) and a bottom surface 13 extends across the perimeter frame 2 covering an opening created by the perimeter frame 2. A preferably rectangular-shaped entrance hole 14 is centrally located on the covering panel 11 and covered by a trap door 15, which is hingedly attached to the covering panel 11 and or perimeter frame 2. The trap door 15 is pushed open by the force water when the pool cleaning device 1 is pushed forward (as illustrated in FIG. 4). A closing means 16, such as at least one spring 30, at least one float 31 and so forth, pushes the trap door 15 into a closed position and maintains the trap door 15 in the closed position when the pool cleaning device 1 is not being pushed forward through the water, thereby capturing debris within the net 10. A substantially rectangular-shaped scoop 17 having a front edge 18, a top surface 19 (as illustrated in FIGS. 1 and 2), and a bottom surface 20 extends from on the front section 7 of the perimeter frame 2 and scrapes the surface of the pool floor to direct debris into the net 10. At least one rolling means 21, such as at least one wheel 22, roller, caster and so forth, may be located on the bottom surface 21 of the scoop 17 and or perimeter frame 2 to allow the pool cleaning device 1 to move freely along the surface of the pool floor. A tubular extension 27 extends from the rear section 9 of the perimeter frame and acts as a handle or an attachment point for an elongated handle.

With reference to FIGS. 5 and 6, perspective side views of a perimeter frame 2 of a pool cleaning device 1 of the present invention with no covering panel 11 and having a removable net 10 attached thereto and a the removable net 10 detached, respectively, are illustrated. The net 10 of the present invention is preferably interchangeable wherein a band 23 is located around an upper perimeter 24 of the bag-shaped net 10. The band 23 preferably has a hook and loop fastener 25 located on an outer surface 24 thereof that engages a hook and loop fastener 25 located on the inner surface 3 of the perimeter frame 2. Said perimeter frame 2 having a rounded and/or rectangular shape. Said perimeter frame 2 comprises an inner surface 3, an outer surface 4, an upper edge 5, a lower edge 6, a front section 7, side sections 8 and at least one rear section 9. The net 10 may be removeably attached to the perimeter frame 2 via any attachment means 26, such as hook and loop fastener 25, clips, hooks, snaps and so forth. A tubular extension 27 extends from the rear section 9 of the perimeter frame and acts as a handle or an attachment point for an elongated handle.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A pool cleaning device comprising:
a perimeter frame having a front section, side sections and at least one rear section;
a net extending downward from the perimeter frame to form a bag for trapping debris that enters the pool cleaning device;
a covering panel having a top surface and a bottom surface;
said covering panel extending across the perimeter frame covering an opening to the net;
an entrance hole located on the covering panel; and
said entrance hole being covered by a trap door hingedly attached to said front section of said perimeter frame.
a tubular extension extending from the rear section of the perimeter frame.

2. (canceled)

3. The pool cleaning device of claim 1 wherein:
at least one spring located on said trap door for maintaining the trap door in a closed position.

4. The pool cleaning device of claim 1 wherein:
at least one float located on said trap door for maintaining the trap door in a closed position.

5. The pool cleaning device of claim 1 further comprising:
a rectangular-shaped scoop having a front edge, a top surface, and a bottom surface extending from the front section of the perimeter frame.

6. The pool cleaning device of claim 5 further comprising:
at least one wheel located on said scoop of the pool cleaning device.

7. The pool cleaning device of claim 1 further comprising:
a tubular extension extending from the rear section at least one of the perimeter frame.

8. The pool cleaning device of claim 1 wherein:
said net is removeably attachable to the perimeter frame via a hook and loop fastener.

9. (canceled)

10. The pool cleaning device of claim 1 further comprising:
at least one weight located in said net.

11. The pool cleaning device of claim 1 further comprising:
at least one support arm extending from said perimeter frame into said net to support said net in an extended position.

12. A pool cleaning device comprising:
a perimeter frame having an inner surface, an outer surface, a front section, side sections and at least one rear section;
a hook and loop fastener located on said perimeter frame;
a net extending downward from the perimeter frame to form a bag for trapping debris that enters the pool cleaning device;
said net having an upper perimeter having a hook and loop fastener located along said upper perimeter that is removeably attachable to said hook and loop fastener located on said perimeter frame; and
a tubular extension extending from the at least one rear section of the perimeter frame.

13. (canceled)

14. (canceled)

15. (canceled)

16. The pool cleaning device of claim 12 further comprising:
a covering panel having a top surface and a bottom surface;
said covering panel extending across the perimeter frame covering an opening to the net;
an entrance hole located on the covering panel; and
said entrance hole being covered by a trap door hingedly attached to the covering panel.

17. The pool cleaning device of claim 16 further comprising:
at least one spring located on said trap door that pushes the trap door into a closed position and maintains the trap door in the closed position when the pool cleaning device is not being pushed forward through water.

18. (canceled)

19. The pool cleaning device of claim 16 wherein:
at least one float located on said trap door that pushes the trap door into a closed position and maintains the trap door in the closed position when the pool cleaning device is not being pushed forward through water.

20. The pool cleaning device of claim 16 further comprising:
a rectangular-shaped scoop having a front edge, a top surface, and a bottom surface extending from the front section of the perimeter frame.
